(19) United States
(12) Patent Application Publication
(10) Pub. No.: US 2006/0138693 A1
(43) Pub. Date: Jun. 29, 2006

(54) Method and apparatus for making a cleaning sheet

(76) Inventors: Scott J. Tuman, Woodbury, MN (US); Thomas E. Haskett, Oakdale, MN (US); Linda W. Suszko, Stillwater, MN (US); Diane R. Wolk, Woodbury, MN (US); Kim C. Sachs, White Bear Lake, MN (US)

Correspondence Address: 3M INNOVATIVE PROPERTIES COMPANY, PO BOX 33427, ST. PAUL, MN, 55133-3427, US

(21) Appl. No.: 11/025,388

(22) Filed: Dec. 29, 2004

(51) Int. Cl. B29C 43/22

(52) U.S. Cl. 264/129; 264/284; 425/373; 425/102; 425/385

(57) ABSTRACT

A method of applying an additive to selected regions of a web includes the steps of applying the additive to the raised regions of a patterned roll having an outer surface comprising raised regions and recessed regions, providing a flat roll having a smooth outer surface arranged in rotatable contact with the patterned roll, and conveying the web of material between the patterned roll and the flat roll, thereby to transfer the additive to selected regions of the web. An apparatus for selectively applying an additive to a web is also described.

### FIELD

The present invention relates generally to a method of applying an additive to a web, and more particularly, to a method of applying an additive, such as adhesive, to selected regions of a web, such as a nonwoven web, thereby to form, for example, a wipe or a cleaning sheet.

### BACKGROUND

Wipes and cleaning sheets with adhesive are known. U.S. Patent Application Publication No. US 2003/0171051 (Bergsten) for example, discloses a wipe including a first wiping member bonded to a backing member along valleys, whereby the wiping member includes a plurality of discrete peaks. In one embodiment, adhesive is provided in the valleys and not on the peaks of the wiping member. Methods of making the wipes are also disclosed.

The industry, however, is always seeking improved ways to produce wipes and seeking improvements to the wipes themselves. It would therefore be desirable to provide a simpler, more efficient, and more reliable way of producing wipes. It would also be desirable to provide wipes that are more effective, less expensive, and more durable.

### SUMMARY OF THE INVENTION

The present invention provides a method of selectively applying an additive to a web of material to form, for example, a wipe or cleaning sheet. The method generally includes conveying a web of material, such as a non-woven web of material, between a pair of rollers. One roller is a patterned roll having an outer surface with raised and recessed regions and the other roll has a generally smooth outer surface. The raised region of the patterned roll is coated with an additive, such as adhesive, such that as the web is conveyed between the two rollers, selected regions of the web that are engaged by the raised region of the patterned roll are simultaneously compressed and coated with adhesive.

More specifically, the method includes the steps of providing a patterned roll having an outer surface with a raised surface region and a recessed surface region, coating an additive on the raised surface region of the patterned roll without coating the additive on the recessed surface region of the patterned roll, providing a flat roll having a generally smooth outer surface arranged in rotatable contact with the patterned roll, and conveying the web of material between the patterned roll and the flat roll, thereby to transfer the additive to selected regions of the web. In one aspect of the invention, the web may be relatively thick and may be formed of a permanently deformable material, thereby allowing the processed web to be formed with a macroscopically three dimensional surface topography.

The method preferably comprises the step of permanently compressing or embossing the web, thereby forming a web having a three-dimensional surface topography with raised and recessed surface regions. In a particular aspect of the invention, the step of applying the additive to the web and the step of embossing the web occur simultaneously. In another aspect, the additive is transferred to only the recessed regions of the embossed web. The additive is preferably a tacky polymer, more preferably an adhesive, even more preferably a pressure-sensitive adhesive, and even more preferably an acrylate adhesive.

In a preferred aspect, the input web is compressible and is capable of retaining a compressed shape indefinitely. The web may comprise foam, sponge, and fibrous material. In one embodiment, the fibrous material may be a nonwoven material comprising semi-synthetic, natural, regenerated fibers, and combinations thereof. In addition, the nonwoven web may be a carded web, an air laid web, a spunbonded web, a melt blown web, a spunlaced web, a creped web, and combinations thereof. In a specific embodiment, the nonwoven web is a blend of at least two types of fibers. The blend of fibers may include binder fibers which, in one embodiment, are heat activated. The fibers may have a denier of about 1 to about 50. The web may have a basis weight of about 10 grams/m² to about 150 grams/m². In addition, the web may have an initial uncompressed thickness of about 0.1 millimeters to about 25 millimeters.

In a more specific embodiment, the web may further include a backing layer. The backing layer may be a net, foam, a knitted fabric, a woven fabric, a nonwoven web, paper, a plastic film, filaments, or laminates thereof. In one aspect, the backing layer may be elastic.

In another aspect, the recessed surface region of the patterned roll may include a plurality of discrete depressions separated by the raised surface region. In a more specific aspect, the raised surface region of the patterned roll may include a continuously interconnected surface, and in an even more specific aspect, the continuously interconnected surface may be provided in a rectilinear array. In one embodiment, the raised surface region of the patterned roll comprises a plurality of discrete peaks. In another embodiment, the peaks of the patterned roll have a corrugated structure. The corrugations may be formed in the machine direction or the transverse direction. In a specific aspect, the recesses of the patterned roll have a depth of about 1 millimeter to about 4 millimeters. In another aspect, the circumferential distance between the centers of adjacent recesses of the patterned roll ranges from about 5 millimeters to about 20 millimeters. In one embodiment, the surface area of the raised surface region may comprise at least about 50% of the total outer surface area of the patterned roll. The recesses may have a diamond, circular, oval, triangular, square, rectangular, hexagonal or octagonal shaped cross-sectional opening. In addition, the cross-sectional area of each recess opening is generally from about 2 mm² to about 100 mm².

In another embodiment, the invention further comprises a transfer roll arranged to transfer the additive to the raised regions of the patterned roll.

In another aspect of the invention, the patterned roll may be heated to a temperature of at least about 250° F. In yet another aspect, the transfer roll may be heated to a temperature of at least 300° F.

The invention also provides a web made according to the described method, and more preferably to a cleaning sheet made according to the described method.

In a specific aspect, the present invention provides a method of simultaneously forming a three-dimensional web and selectively applying adhesive to the web to produce a three-dimensional cleaning sheet in which the method includes (a) providing an adhesive transfer roll having an outer surface arranged in rotating contact with a patterned roll; (b) applying a layer of pressure-sensitive adhesive to the outer surface of the adhesive transfer roll; (c) providing a patterned roll having an outer surface comprising raised regions and recessed regions; (d) rotating the patterned roll and the adhesive transfer roll into contact to transfer adhesive to the raised regions of the patterned roll; (e) providing a flat roll having a generally smooth outer surface arranged in rotatable contact with the patterned roll; (f) providing a single layer, compressible, carded, nonwoven web of material comprising a blend of fibers formed of different materials and different sizes, said web having a thickness of at least about 0.5 millimeters and a basis weight of about 10 grams/m² to about 100 grams/m²; and (g) conveying the web of material between the patterned roll and the flat roll, thereby to simultaneously compress and transfer the pressure-sensitive adhesive to selected regions of the web.

The invention also provides an apparatus for selectively applying an additive to a web of material. The apparatus includes a transfer roll having an outer surface, a dispenser arranged to deposit the additive on the outer surface of the transfer roll, a patterned roll arranged in rotatable contact with the transfer roll, the patterned roll having an outer surface with a raised surface region and a recessed surface region, and a flat roll having a generally smooth outer surface arranged in rotatable contact with the patterned roll, whereby a web of material can be conveyed between the patterned roll and the flat roll to transfer the additive to selected regions of the web.

In a more specific embodiment, the invention provides an apparatus for simultaneously forming a three-dimensional web and selectively applying adhesive to the web to produce a three-dimensional cleaning sheet, wherein the apparatus includes an adhesive transfer roll having an outer surface arranged in rotating contact with a patterned roll; a dispenser for applying a layer of pressure-sensitive adhesive to the outer surface of the adhesive transfer roll; a patterned roll having an outer surface comprising raised regions and recessed regions; a flat roll having a generally smooth outer surface arranged in rotatable contact with the patterned roll; means for providing a single layer, compressible, carded, nonwoven web of material comprising a blend of fibers formed of different materials and different sizes, the web having a thickness of at least about 0.5 millimeters and a basis weight of about 10 grams/m² to about 150 grams/m²; and means for conveying the web of material between the patterned roll and the flat roll, thereby to simultaneously compress and transfer the pressure-sensitive adhesive to selected regions of the web.

### BRIEF DESCRIPTION OF THE DRAWINGS

The present invention will be further described with reference to the accompanying drawings, in which:

FIG. 1 is a schematic representation of an apparatus according to the invention for selectively applying an additive to a web;

FIG. 2 is a perspective view of the flat roll of FIG. 1;

FIG. 3 is a perspective view of the patterned roll of FIG. 1; and

FIG. 4 is a perspective view of a cleaning sheet made according to the method and apparatus of the invention.

### DETAILED DESCRIPTION

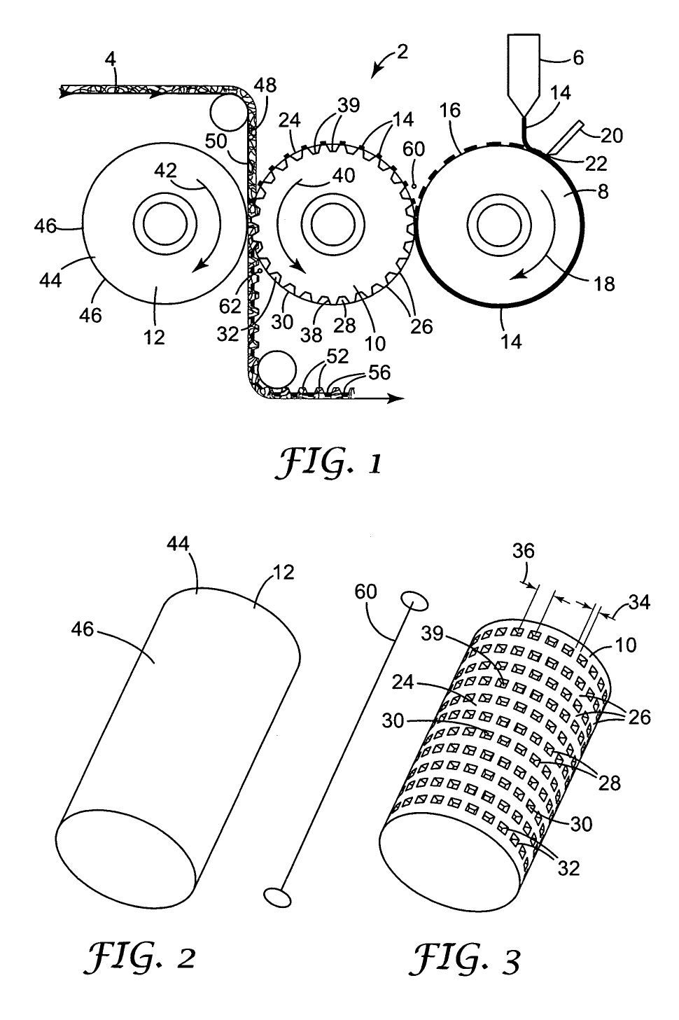

Referring now to the drawings, wherein like reference numerals refer to like or corresponding parts throughout the several views, FIG. 1 shows an apparatus 2 for selectively applying an additive 14 to a web of material 4. The apparatus 2 generally includes a dispenser 6, a transfer roll 8, a patterned roll 10, and a flat roll 12. In the illustrated embodiment, the dispenser 6 dispenses the additive 14 onto the outer surface 16 of the transfer roll 8. The transfer roll 8 rotates clockwise as indicated by arrow 18. In a particular embodiment, the additive 14 is adhesive and the transfer roll 8 is an adhesive transfer roll that rotatably engages the patterned roll 10 to transfer adhesive from the transfer roll 8 to the patterned roll 10.

In the illustrated embodiment, a doctor blade 20 is provided adjacent the outer surface 16 of the transfer roll 8 to spread the additive 14 uniformly over the entire outer surface 16 of the transfer roll 8. The blade 20 evenly distributes the additive 14 and produces a smooth layer having a generally uniform and constant thickness. Alternatively, the additive may be coated in a discontinuous fashion or coated to a variable thickness.

The desired thickness of the additive 14 applied to the transfer toll 8 will depend on the type of additive, the intended end use application for the web, and on the geometry of the patterned roll 10. In the case where the additive is an adhesive and the web 4 is a nonwoven material useful as a cleaning sheet, the thickness of the adhesive 14 generally ranges from a minimum of about 1 mil and, more particularly, at least about 2 mils to a maximum of no greater than about 7 mils and, more particularly, no more than 5 mils. In a specific embodiment, the adhesive is coated to a thickness of approximately 3 mils. The gap 22 between the doctor blade 20 and the outer surface 16 of the adhesive transfer roll 8 may be adjusted to control the thickness of the adhesive layer on the adhesive transfer roll 8.

Other known methods of applying the additive to the outer surface 16 of the transfer roll 8, such as spraying the additive directly on the outer surface 16 of the transfer roll 8 or using gravure coating to coat the outer surface 16 of the adhesive transfer roll with additive, may also be used and are considered within the scope of the present invention. In addition, the additive may be applied in strips using known pattern coating techniques to produce regions having additive applied thereto and adjacent regions free of additive.

The transfer roll 8 is arranged to rotate into contact with the patterned roll 10. Referring to FIGS. 1 and 3, the patterned roll 10 includes an outer surface 24 having an elevated or raised surface region 26 and recessed surface regions 28 defined by a plurality of discrete indentations, depressions, cavities, or recesses 30. It will be recognized that the raised surface region 26 and recessed surface regions 28 of the outer surface 24 of the patterned roll 10 may come in a wide variety of patterns depending on the desired pattern of additive to be provided on the web 4 and desired topography of the processed web.

In the illustrated embodiment, the raised surface region 26 is a continuously interconnected surface. That is, the entire raised surface region 26 is a lattice that forms a single patterned surface. The raised surface region 26 surrounds the individual recesses 30. In general, the raised surface region 26 comprises at least about 20%, more generally at least about 50% and, more particularly, at least about 66% of the total outer surface area 24 of the patterned roll 10. Stated another way, the ratio of the area of the raised surface region 26 to the combined area of the openings 32 of the recesses 30 is typically at least about 1:5, more generally at least about 1:1 and, more particularly, at least about 2:1.

In the illustrated embodiment, the recesses 30 are discrete depressions or cavities having an inverted frusto-pyramidal shape. Each recess 30 is separated by the raised surface region 26. The opening 32 of each recess 30 (which corresponds to the base of the inverted frusto pyramid) typically has a minimum cross-sectional area of at least about 2 square millimeters (mm²), more typically at least about 5 mm²), and even more typically at least 10 mm². The opening 32 typically has a maximum cross-sectional area of no greater than about 100 mm², more typically no greater than about 50 mm², and even more typically no greater than about 25 mm². In a particular embodiment, the openings 32 have a cross-sectional area of approximately 15 square millimeters (mm²). The recesses 30 have a minimum depth 38 (which corresponds to the height of the inverted frusto-pyramid) of at least about 0.5 millimeters (mm), more particularly at least about 1 mm, and even more particularly, at least about 1.5 mm, and a maximum depth of no greater than about 5 mm, more particularly, no greater than about 4 mm, and even more particularly, no greater than about 3.5 mm. In a particular embodiment, the recesses 30 have a depth 38 of approximately 3 mm.

The minimum circumferential distance 34 between adjacent recesses 30 is typically at least about 3 mm, more typically at least about 5 mm, and even more typically, at least about 7 mm, and the maximum circumferential distance 34 between adjacent recesses 30 is typically no greater than about 25 mm, more typically no greater than about 12 mm, even more typically no greater than about 10 mm. In a particular embodiment, the circumferential distance 34 between adjacent recesses 30 is approximately 8 mm, and the circumferential distance 36 between the centers of adjacent recesses 30 is approximately 12 mm. The openings 32 may have a wide variety of cross sectional shapes including, for example, circles, squares, triangles, ovals, or diamonds. In addition, the side surfaces of the recesses may be sloped or tapered inwardly in the direction away from the openings 32 as illustrated in FIGS. 1 and 3, or the side surfaces may be parallel.

When the transfer roll 8 and patterned roll 10 rotate into contact, the additive 14 is transferred from the outer surface 16 of the transfer roll 8 to the raised surface region 26 of the patterned roll 10. Some additive may be transferred to the sloping side surfaces of the recess 30 but essentially no additive is transferred to the bottoms 39 of the recesses 30. The outer surface 24 of the patterned roll 10 is designed so that the additive 14 is transferred to the raised surface region 26 but is not transferred into the bottoms 39 of the recesses 30. This is accomplished by selecting a suitable additive, adjusting or controlling the visco-elastic properties of the additive, controlling the thickness of the additive layer 14 coated onto the transfer roll 8, and designing the recesses 30 on the patterned roll 10 to have a sufficiently large cross-sectional opening area 32 and depth 38 to prevent the additive 14 from being transferred to the bottoms 39 of the recesses 30.

In one embodiment of the invention, the additive is a tacky polymer such as an adhesive and, more particularly, a pressure-sensitive adhesive. The particular adhesive is not critical to the invention so long as a generally uniform layer of adhesive can be transferred from the transfer roll 8 to the raised surface region 26 of the patterned roll 10.

Suitable adhesives include any that are capable of being tacky at room temperature, including both adhesives that are initially tacky and those that are initially non-tacky but which can be activated to become tacky. Suitable adhesives include any pressure-sensitive adhesives, including materials based on acrylates, silicones, poly-alpha-olefins, polyisobutylenes, rubber block copolymers (such as styrene/isoprene/styrene and styrene/butadiene/styrene block copolymers), styrene butadiene rubbers, synthetic isoprenes, natural rubber, and blends thereof. The pressure-sensitive adhesives may be coated from solvent, from water, radiation polymerized, or hot melt processed. These pressure-sensitive adhesives may or may not be crosslinked. Crosslinking can be done by well-known methods, including chemical, ionic, physical, or radiation-induced processes. To improve the cohesive strength of the adhesive once deposited into the valleys of the wiping member, some crosslinking may be used.

To allow for low viscosity for easy processing while providing for good cohesive strength, adhesives with physical crosslinking, ionic crosslinking, or some form of post-crosslinking are preferred. Post-crosslinking can be carried out by exposing the adhesive to radiation, such as electron-beam or high intensity ultraviolet (UV) radiation. For UV crosslinking, it may be desirable to incorporate a photo-receptive group into the polymer backbone to facilitate the crosslinking reaction.

U.S. Pat. No. 4,737,559 (Kellen et al.) discloses examples of such UV-crosslinked adhesives. Physical or ionic crosslinking provide the advantage that the process is thermally reversible, making it particularly preferred for hot-melt processing. Physically crosslinked adhesives include those based on rubber block copolymers. Examples of synthetic rubber block copolymers include Kraton™ commercially available from Kraton Polymers of Houston, Tex., and Vector™ commercially available from Exxon-Mobil of Houston, Tex. These block copolymers are typically formulated into pressure-sensitive adhesives by compounding them with tackifiers and/or oils. Other physically crosslinked adhesives include macromer grafted polymers as disclosed in U.S. Pat. No. 5,057,366 (Husman et al.).

The adhesives useful in this invention may be tacky under both dry and wet conditions. Adhesives with high tack under wet conditions are disclosed in a PCT Publication Number WO 00/56828. The pressure-sensitive adhesives may also be coated from water in the form of a latex or dispersion. These adhesives may be based on polymers like natural rubber, acrylates, styrene-butadienes, and vinyl ethers. Especially when coated directly on a porous, woven, or nonwoven substrate, the latex adhesives may not be viscous enough to prevent excessive penetration into the substrate. Whereas the viscosity and flow of the latex adhesive may be controlled by the solids content of the material, it may be more beneficial to formulate the latex with thickening agents. Thickening agents are typically categorized as water-soluble polymers or associative thickeners. In the case of pressure-sensitive adhesives, particular care has to be taken in the selection of the thickening agent so it does not interfere with the adhesive properties.

A suitable adhesive is a 95% iso-octyl acrylate, 5% acrylic acid hot melt pressure-sensitive adhesive. Such adhesives are described in U.S. Pat. No. 5,753,768.

To control the viscosity and improve the transfer of the adhesive between the transfer roll 8 and the raised surface region 26 of the patterned roll 10, the transfer roll 8 and patterned roll 10 may be heated. In certain embodiments, the transfer roll 8 and patterned roll 10 are maintained at a minimum temperature of at least about 200° F., more particularly at least about 250° F., and even more particularly at least about 300° F., and at a maximum temperature of no greater than about 350° F., more typically no greater than about 325° F., and even more typically, no greater than about 310° F. The transfer roll 8 and patterned roll 10 are preferably heated to a minimum temperature so the adhesive does not coagulate or solidify before it is applied to the web 4. The minimum temperature depends of the adhesive but is generally at least 200° F.

Heating the transfer roll 8 and patterned roll 10 reduces the formation of adhesive “strands” (not shown) that may stretch between the transfer roll 8 and the patterned roll 10 during the coating process. Such strands may form for certain adhesives at high processing speeds. Upon breaking, the adhesive strands may result in adhesive being inadvertently transferred to the bottoms 39 of the recesses which, in turn, causes adhesive to be transferred to the raised regions 52 of the web. The formation of adhesive strands depends on a number of factors including the type of adhesive being transferred, the coating weight of the adhesive, and the processing speed (i.e. the rotational speed of the transfer roll 8 and the patterned roll 10). The formation of adhesive strands can be controlled, for example, by adjusting the coating weight of the adhesive, adjusting the line speed, adjusting the temperature and viscosity of the adhesive, or by adding additives and fillers to the adhesive.

The adhesive typically has a minimum viscosity of about 4000 centipoise (cps), more particularly, at least about 10,000 cps, and most particularly, at least about 25,000 cps, and a maximum viscosity of no greater than about 200,000 cps, more particularly, no greater than about 150,000 cps, and most particularly, no greater than about 100,000 cps at the applied temperature.

In the illustrated embodiment, an adhesive separating element 60 is arranged between the transfer roll 8 and the patterned roll 10 to break or cut any strands of adhesive that may bridge the gap between the transfer roll 8 and the patterned roll 10 after the transfer roll 8 and patterned roll 10 have been rotated into contact and begin to separate. The adhesive separating element 60 may be, for example, a heated wire, an ultrasonic device, a laser, a high pressure water jet, or a high pressure air stream. To maximize the likelihood that any strands will be cut in a controlled manner by the adhesive separating element 60, the element 60 is located as close as possible to the location where the surfaces of the transfer roll 8 and patterned roll 10 disengage. In a particular embodiment, the adhesive separating element 60 is located no more than one mm from the location where the transfer roll 8 and patterned roll 10 disengage.

In the illustrated embodiment, the adhesive separating element 60 is an electrically resistive heating element, such as a NICHROME heating element or wire, that cuts any adhesive strands that may bridge the gap between the transfer roll 8 and the patterned roll 10 as the rolls disengage. The element 60 is typically heated to a high enough temperature to burn any residual adhesive that may adhere to the element 60 during the cutting process so that adhesive does not accumulate on the element 60. The particular temperature needed for the element 60 will depend on the adhesive used but will typically be at least about 500° F., and more particularly, at least about 600° F.

A second adhesive separating element 62 may be arranged between the web 4 and the patterned roll 10 to cut any adhesive strands that form between the web 4 and the patterned roll 10 as adhesive is transferred from the patterned roll 10 to the web 4. The second adhesive separating element 62 may be identical to the first adhesive separating element 60. The second adhesive separating element 62 is arranged adjacent the adhesively coated first major surface 48 of the web 4 as the web 4 exits the flat and patterned rolls 12,10.

The patterned roll 10 rotates counterclockwise as indicated by arrow 40 into contact with the flat roll 12 which rotates clockwise as indicated by arrow 42. In accordance with a characterizing feature of the invention, the outer surface 44 of the flat roll 12 is generally smooth. That is, the outer surface 44 of the flat roll 12 does not include protrusions that engage the recesses 30 of the patterned roll 10 and is otherwise generally free of macroscopic dimensionality.

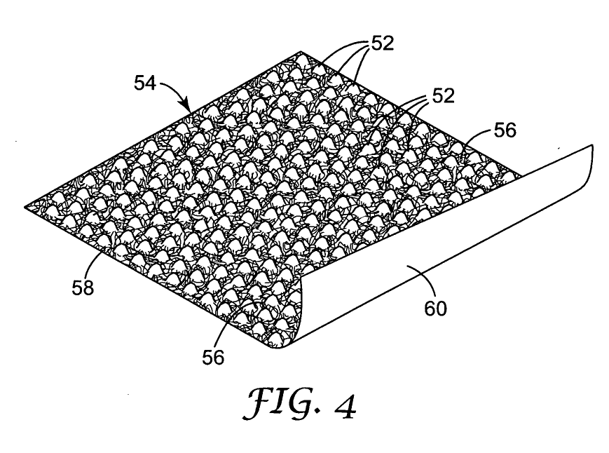

The web 4 is conveyed between the flat roll 12 and patterned roll 10. The web 4 includes a first major surface 48 that faces the patterned roll 10 and a second major surface 50 that faces the flat roll 12. As the web 4 is conveyed between the flat 12 and patterned 10 rolls, the raised surface region 26 of the patterned roll 10 forces the web 4 against the outer surface 44 of the flat roll 12, thereby simultaneously compressing the web and transferring the additive 14 to the compressed regions 56 (FIG. 4) of the processed web 4. Depending on the thickness, density, and compressibility of the input web 4, the compressed regions 56 may form a recessed region having additive applied thereto as depicted in FIG. 4.

The particular web material has physical properties sufficient to withstand the physical requirements of the manufacturing process and is also capable of having an additive transferred to at least one of its surfaces. In accordance with a characterizing aspect of the invention, if the web is to be provided with a contoured or three-dimensional topography, the web is also capable of withstanding the formation of the contoured topography and is capable of retaining the contoured shape indefinitely after the surface topography has been created. Thus, in one embodiment, the input web 4 is thick enough to allow a macroscopically three dimensional surface topography to be formed into the web, and is also permanently deformable so when the web is conveyed between the patterned roll 10 and the flat roll 12, a web having a three-dimensional surface topography is produced.

The web 4 may be foam, sponge or a fibrous material such as a knitted or woven fabric, or a nonwoven web. A preferred web is a nonwoven web. The nonwoven web may be prepared by any suitable melt forming or mechanical forming operation. For example, the nonwoven web may be carded, spunbonded, spunlaced, melt blown, air laid, creped, or made by other processes known in the art.

Preferred webs include nonwoven webs made from one or more of a variety of thermoplastic polymers that are known to form fibers. Suitable thermoplastic polymers can be selected from polyolefins (such as polyethylenes, polypropylenes, and polybutylenes), polyamides (such as nylon 6, nylon 6/6, and nylon 10), polyesters (such as polyethylene terephthalate), copolymers containing acrylic monomers, and blends and copolymers thereof. Semi-synthetic fibers (such as acetate fibers), natural fibers (such as cotton), regenerated fibers (such as rayon), and other non-thermoplastic fibers can also be blended with the thermoplastic fibers. In a preferred embodiment, the web includes a blend of fibers and one of the fibers is a binder fiber. In one embodiment, the binder fibers are activated by heat. Such binder fiber may comprise from about 5% to about 90% of the web weight and more generally from about 30% to about 50%. A suitable binder fiber is available under the trade designation CELBOND T254 12 denier fiber available from Kosa Incorporated, Wichita, Kans.

The fibers typically have a minimum denier of at least about 1, more typically at least about 2, and even more typically at least about 5, and a maximum denier of no greater than about 50, more typically no greater than about 30, and even more typically no greater than about 15. The web typically has a minimum basis weight of at least about 5 grams per square meter (g/m²), more typically at least about 10 g/m², and even more typically at least about 20 g/m², and a maximum basis weight of no greater than about 150 g/m², more typically no greater than about 100 g/m², and even more typically no greater than about 75 g/m². The web 4 typically has a minimum uncompressed thickness of at least about 0.1 mm, more typically at least about 0.2 mm, and even more typically at least about 0.5 mm, and a maximum uncompressed thickness of no greater than about 25 mm, more typically no greater than about 8 mm, and even more typically no greater than about 5 mm.

A particularly suitable web 4 is a carded web formed of a blend of two sizes of polyester fibers, the first fibers having a denier of about 24 and the second having a denier of about 10-15. The web has a basis weight of about 50 g/m² and a thickness of about 3 mm.

In addition, the web 4 may include a backing layer along, for example, the second major surface 50 (not shown) such as a net, a foam, a knitted or woven fabric, a nonwoven web, paper, a plastic film, or laminates thereof. The backing layer may also comprise a scrim or strands of fiber. The backing layer may be permanently or releaseably connected to the web. When the backing layer is a nonwoven layer or a knitted or woven fabric, it may optionally serve as a second wiping surface.

If a plastic film is used as the backing layer, a polyolefin (such as polypropylene or polyethylene), a polyamide, a polyester, or other film may be used. The thickness of the film may be from about 0.012 mm (0.5 mils) to about 0.075 mm (3 mils). If the film is extrusion bonded to a nonwoven web, then it is preferable that the nonwoven web and the film backing layer be of compatible materials so that adequate bonding between the two members is obtained.

To selectively coat the web 4 with additive 14, and thereby form a cleaning sheet having additive applied to selected regions of the web 4, the additive 14 is first applied to the entire outer surface 16 of the transfer roll 8. The additive 14 is applied to the outer surface 16 of the transfer roll 8 in a narrow stream that is then spread and evenly distributed over the entire outer surface 16 of the transfer roll 8 by the doctor blade 20 to form a continuous and uniform layer of the additive having a desired thickness.

The transfer roll 8 is then rotated into contact with the raised surface region 26 of the patterned roll 10, thereby transferring additive 14 from the outer surface 16 of the transfer roll 8 to the raised surface region 26 of the patterned roll 10. The coated raised surface region 26 of the patterned roll 10 is then rotated into contact with the web 4 at a speed matching the speed of the web 4. In this manner, additive from the raised surface region 26 of the patterned roll 10 is transferred to specific discrete regions of the web 4.

The amount of additive 14 applied to the web 4 will depend on a number of factors including the type of additive and the physical characteristics of the web. In the case where a cleaning sheet is being produced and the additive is an adhesive, the amount of adhesive should be sufficient for the cleaning sheet to capture both small and large particles of various shapes and consistencies, such as lint, dust, hair, sand, food particles, dirt, and the like, without having excess adhesive that could create drag and make wiping difficult or that could transfer to the surface being cleaned. Of course, the greater the three-dimensional surface topography of the cleaning sheet, the greater the amount of adhesive that can be provided on the cleaning sheet without creating excessive drag or transferring adhesive to the surface being cleaned.

The web 4 will typically include from about 2 weight % to about 50 weight % of adhesive, more typically from about 10 weight % to about 20 weight % of adhesive, based on the weight of the input nonwoven web. Also, the planar ratio between areas of the web that have adhesive and those that either have no adhesive may range from about 80:20 to about 20:80.

The adhesive is typically coated onto the web at a minimum weight of about 1 gram/m², more typically at least about 2.5 grams/m², and even more typically at least about 4 grams/m², and at a maximum weight of no more than about 25 grams/m², more typically no more than about 15 gram/m², and even more typically no more than about 8 grams/m².

It will be recognized that if the input web 4 is relatively thin, incompressible or resilient, the process will apply additive to selected regions of the web 4 but will not impart significant three-dimensionality to the web 4. That is, the processed output web will be substantially flat with generally planar opposed major surfaces.

In accordance with a preferred aspect of the invention, however, the input web 4 is relatively thick and permanently deformable. When such an input web is used in the process, an output web having a macroscopically three-dimensional surface topography is produced. That is, if the input web 4 has sufficient thickness and is capable of being permanently deformed, the process will produce a web having a three-dimensional surface topography consisting of recessed regions coated with additive where the web 4 is compressed, and raised regions substantially free of adhesive where the web 4 is not compressed.

A cleaning sheet 54 produced according to the method and apparatus of the invention is shown in FIG. 4. The cleaning sheet 54 has a first major surface 58 having lofty uncompressed raised regions or peaks 52 and compressed recessed regions or valleys 56, and a generally planar second major surface 60. Such a surface topography is particularly desirable when the additive is an adhesive because the peaks 52 serve to space the adhesive from the surface being cleaned, thereby minimizing the level of drag that could interfere with the use of the cleaning sheet. To form the cleaning sheet 54 from the processed web 4, the web 4 is simply cut to the desired size and/or shape.

It will be apparent to those of ordinary skill in the art that various changes and modifications may be made without deviating from the inventive concept set forth above. For example, it will be recognized that the pattern of raised and recessed regions may take a variety of forms such as, for example, a corrugated-like pattern consisting of a plurality of elongated generally parallel alternating raised and recessed regions extending in either in the machine direction (i.e. running continuously the length of the web) or in the transverse direction (i.e. running across the width of the web). Thus, the scope of the present invention should not be limited to the features described in this application, but only by the features described by the language of the claims and the equivalents of those features.

What is claimed is:

1. A method of selectively applying an additive to a web of material, said method comprising the steps of:
(a) providing a patterned roll having an outer surface with a raised surface region and a recessed surface region;
(b) coating the additive on the raised surface region of the patterned roll without coating the additive on the recessed surface region of the patterned roll;
(c) providing a flat roll having a generally smooth outer surface arranged in rotatable contact with the patterned roll; and
(d) conveying the web of material between the patterned roll and the flat roll, thereby to transfer the additive to selected regions of the web.

2. A method as defined in claim 1, wherein the web is permanently deformable.

3. A method as defined in claim 1, wherein the method further comprises the step of embossing the web, thereby to form a web having a three-dimensional surface topography with raised and recessed surface regions.

4. A method as defined in claim 3, wherein the step of applying the additive to the web and the step of embossing the web occur simultaneously.

5. A method as defined in claim 4, wherein the additive is transferred to only the recessed regions of the embossed web.

6. A method as defined in claim 1, wherein the additive is a tacky polymer.

7. A method as defined in claim 1, wherein the additive is an adhesive.

8. A method as defined in claim 1, wherein the additive is a pressure-sensitive adhesive.

9. A method as defined in claim 8, wherein the pressure-sensitive adhesive is an acrylate adhesive.

10. A method as defined in claim 9, wherein the web is compressible and is capable of retaining the compressed shape indefinitely.

11. A method as defined in claim 10, wherein the web comprises at least one of foam, sponge, and fibrous material.

12. A method as defined in claim 11, wherein the fibrous material is a nonwoven material comprising at least one of semi-synthetic, natural, regenerated fibers, and combinations thereof.

13. A method as defined in claim 12, wherein the nonwoven input web is at least one of a carded web, an air laid web, a spunbonded web, a melt blown web, a spunlaced web, and a creped web.

14. A method as defined in claim 13, wherein the input web has undergone a secondary bonding step.

15. A method as defined in claim 1, wherein the web is a carded web.

16. A method as defined in claim 15, wherein the nonwoven web is a blend of at least two types of fibers.

17. A method as defined in claim 16, wherein the blend of fibers includes binder fibers.

18. A method as defined in claim 17, wherein the binder fibers are heat activated.

19. A method as defined in claim 18, wherein the binder fiber comprises about 5% to about 90% of the web weight.

20. A method as defined in claim 19, wherein the web comprises polyester fibers.

21. A method as defined in claim 20, wherein the fibers have a denier of about 1 to about 50.

22. A method as defined in claim 1, wherein the web has a basis weight of about 10 grams/m² to about 150 grams/m².

23. A method as defined in claim 22, wherein the web has an initial uncompressed thickness of about 0.1 millimeters to about 25 millimeters.

24. A method as defined in claim 1, wherein the web further comprises a backing layer.

25. A method as defined in claim 24, wherein the backing layer is at least one of a net, a foam, a knitted fabric, a woven fabric, a nonwoven web, paper, a plastic film or laminate thereof.

26. A method as defined in claim 25, wherein the backing layer is elastic.

27. A method as defined in claim 1, wherein the recessed surface region of the patterned roll comprises a plurality of discrete depressions separated by the raised surface region.

28. A method as defined in claim 27, wherein the raised surface region of the patterned roll comprises a continuously interconnected surface.

29. A method as defined in claim 28, wherein the continuously interconnected surface is provided in a rectilinear array.

30. A method as defined in claim 29, wherein the raised surface region of the patterned roll comprises a plurality of discrete peaks.

31. A method as defined in claim 30, wherein the peaks of the patterned roll have a corrugated structure.

32. A method as defined in claim 1, wherein the recesses of the patterned roll have a depth of about 1 millimeter to about 4 millimeters.

33. A method as defined in claim 32, wherein the circumferential distance between the centers of adjacent recesses of the patterned roll ranges from about 5 millimeters to about 25 millimeters.

34. A method as defined in claim 33, wherein the surface area of the raised surface region comprises at least about 20% of the total outer surface area of the patterned roll.

35. A method as defined in claim 34, wherein the recesses have a diamond, circular, oval, triangular, square, rectangular, hexagonal or octagonal shaped cross-sectional opening.

36. A method as defined in claim 35, wherein the cross-sectional area of a recess opening is from about 2 mm² to about 100 mm².

37. A method as defined in claim 36, wherein the patterned roll is heated to a temperature of at least about 250° F.

38. A method as defined in claim 1, further comprising the step of providing a transfer roll arranged to transfer the additive to the raised regions of the patterned roll.

39. A method as defined in claim 38, wherein the transfer roll is heated to a temperature of at least 300° F.

40. A web made according to the method of claim 1.

41. A cleaning sheet made according to the method of claim 1.

42. A method of simultaneously forming a three-dimensional web and selectively applying adhesive to the web to produce a three-dimensional cleaning sheet, said method comprising the steps of:
(a) providing an adhesive transfer roll having an outer surface arranged in rotating contact with a patterned roll;
(b) applying a layer of pressure-sensitive adhesive to the outer surface of the adhesive transfer roll;
(c) providing a patterned roll having an outer surface comprising raised regions and recessed regions;
(d) rotating the patterned roll and the adhesive transfer roll into contact to transfer adhesive to the raised regions of the patterned roll;
(e) providing a flat roll having a generally smooth outer surface arranged in rotatable contact with the patterned roll;
(f) providing a single layer, compressible, nonwoven web of material, said web having a thickness of at least about 0.5 millimeters and a basis weight of about 10 grams/m² to about 150 grams/m²; and
(g) conveying the web of material between the patterned roll and the flat roll, thereby to simultaneously compress and transfer the pressure-sensitive adhesive to selected regions of the web.

43. A method of simultaneously forming a three-dimensional web and selectively applying adhesive to the web to produce a three-dimensional cleaning sheet, said method comprising the steps of:
(a) providing an adhesive transfer roll having an outer surface arranged in rotating contact with a patterned roll;
(b) applying a layer of pressure-sensitive adhesive to the outer surface of the adhesive transfer roll;
(c) providing a patterned roll having an outer surface comprising raised regions and recessed regions;
(d) rotating the patterned roll and the adhesive transfer roll into contact to transfer adhesive to the raised regions of the patterned roll;
(e) providing a flat roll having a generally smooth outer surface arranged in rotatable contact with the patterned roll;
(f) providing a single layer, compressible, carded, nonwoven web of material comprising a blend of fibers formed of different materials and different sizes, said web having a thickness of at least about 0.5 millimeters and a basis weight of about 10 grams/m² to about 150 grams/m²; and
(g) conveying the web of material between the patterned roll and the flat roll, thereby to simultaneously compress and transfer the pressure-sensitive adhesive to selected regions of the web.

44. An apparatus for selectively applying an additive to a web of material, the apparatus comprising:
(a) a transfer roll having an outer surface;
(b) a dispenser arranged to deposit the additive on the outer surface of the transfer roll;
(c) a patterned roll arranged in rotatable contact with the transfer roll, the patterned roll having an outer surface with a raised surface region and a recessed surface region; and
(d) a flat roll having a generally smooth outer surface arranged in rotatable contact with the patterned roll;
whereby a web of material can be conveyed between the patterned roll and the flat roll to transfer the additive to selected regions of the web.

45. An apparatus for simultaneously forming a three-dimensional web and selectively applying adhesive to the web to produce a three-dimensional cleaning sheet, the apparatus comprising:
(a) an adhesive transfer roll having an outer surface arranged in rotating contact with a patterned roll;
(b) a dispenser for applying a layer of pressure-sensitive adhesive to the outer surface of the adhesive transfer roll;
(c) a patterned roll having an outer surface comprising raised regions and recessed regions;
(d) a flat roll having a generally smooth outer surface arranged in rotatable contact with the patterned roll;
(e) means for providing a single layer, compressible, nonwoven web of material, the web having a thickness of at least about 0.5 millimeters and a basis weight of about 10 grams/m² to about 150 grams/m²; and
(f) means for conveying the web of material between the patterned roll and the flat roll, thereby to simultaneously compress and transfer the pressure-sensitive adhesive to selected regions of the web.

46. An apparatus for simultaneously forming a three-dimensional web and selectively applying adhesive to the web to produce a three-dimensional cleaning sheet, the apparatus comprising:
(a) an adhesive transfer roll having an outer surface arranged in rotating contact with a patterned roll;
(b) a dispenser for applying a layer of pressure-sensitive adhesive to the outer surface of the adhesive transfer roll;
(c) a patterned roll having an outer surface comprising raised regions and recessed regions;
(d) a flat roll having a generally smooth outer surface arranged in rotatable contact with the patterned roll;
(e) means for providing a single layer, compressible, carded, nonwoven web of material comprising a blend of fibers formed of different materials and different sizes, the web having a thickness of at least about 0.5 millimeters and a basis weight of about 10 grams/m² to about 150 grams/m²; and
(f) means for conveying the web of material between the patterned roll and the flat roll, thereby to simultaneously compress and transfer the pressure-sensitive adhesive to selected regions of the web.
